(19) United States
(12) Patent Application Publication
(10) Pub. No.: US 2021/0370482 A1
(43) Pub. Date: Dec. 2, 2021

(54) RATCHET HAND TOOL

(71) Applicant: GONG FONG ENTERPRISE CO., LTD., Tainan City (TW)

(72) Inventors: CHENG-TE HU, TAINAN CITY (TW); NENG-CHIA SHIH, CHANGHUA COUNTY (TW)

(21) Appl. No.: 16/988,877

(22) Filed: Aug. 10, 2020

(30) Foreign Application Priority Data
May 26, 2020 (TW) 109117540

(51) Int. Cl. B25B 15/04; B25B 23/16

(52) U.S. Cl. CPC B25B 15/04; B25B 15/005; B25B 23/16

(57) ABSTRACT

A ratchet hand tool includes a grip, a shaft member, an operating member, a positioning member, two pawls, and a first elastic member. When one of the pushing portions pushes against a corresponding one of the pawls to disengage the pawl toothed portion of the corresponding pawl from an inner toothed portion of the operating member, the corresponding pawl is pivoted through a pivot groove of the shaft member. When the pushing portion stops pushing against the corresponding pawl, the corresponding pawl is pivoted and the pawl toothed portion is engaged with the internal toothed portion. The overall volume of the ratchet hand tool can be reduced, the structure is simple, and the installation is easy.

### FIELD OF THE INVENTION

The present invention relates to a hand tool, and more particularly to a ratchet hand tool.

### BACKGROUND OF THE INVENTION

For hand tools, such as screwdrivers and wrenches, to be operated in a limited working space or to increase working efficiency, a ratchet structure may be provided in the hand tools.

Taiwan Utility Model Publication No. M591460 discloses a ratchet tool, comprising a main body, a ratchet and a pawl. The main body has a first chamber and a second chamber communicating with each other. The ratchet is pivotally disposed in the first chamber. The pawl is accommodated in the second chamber. The pawl includes a toothed portion, a push portion and a side portion. The side portion is formed with an engaging groove. One end of an elastic member is engaged in the engaging groove.

However, in the aforementioned patent, the ratchet occupies most of the space of the first chamber, and the interior of the ratchet is solid. This cannot use the space effectively. In addition to the first chamber and the second chamber, the ratchet tool is relatively large in size, so it is inconvenient for use. Accordingly, the inventor of the present invention has devoted himself based on his many years of practical experiences to solve these problems.

### SUMMARY OF THE INVENTION

The primary object of the present invention is to provide a ratchet hand tool. The ratchet hand tool comprises a grip, a shaft member, an operating member, a positioning member, two pawls, and a first elastic member. The shaft member is disposed in the grip. The shaft member has two pivot grooves. The operating member is sleeved on the shaft member. The operating member is hollow to form a first accommodating space. The operating member has an internal toothed portion corresponding to the first accommodating space. The positioning member is sleeved on the shaft member and adjacent to the operating member. The positioning member is hollow to form a second accommodating space communicating with the first accommodating space. The positioning member is recessed to form a stop groove and has two pushing portions adjacent to the stop groove. The stop groove and the pushing portions correspond to the second accommodating space. The two pawls each have a pawl toothed portion that is selectively engaged with the inner toothed portion and a pivot portion that is integrally formed with the pawl toothed portion and pivotally disposed in a corresponding one of the pivot grooves. The pawls correspond to the first accommodating space and the second accommodating space. The pawls correspond to the pushing portions, respectively. The first elastic member is disposed between the pawls. When one of the pushing portions pushes against a corresponding one of the pawls to disengage the pawl toothed portion of the corresponding pawl from the inner toothed portion, the corresponding pawl is pivoted through the corresponding pivot groove, and the first elastic member is pressed to store an elastic potential energy. When the pushing portion stops pushing against the corresponding pawl, the first elastic member releases the elastic potential energy so that the corresponding pawl is pivoted through the corresponding pivot groove, and the pawl toothed portion of the corresponding pawl is engaged with the internal toothed portion.

Preferably, the shaft member has a shaft rod disposed in the grip.

Preferably, each of the pawls has a recess, and two ends of the first elastic member are disposed in the recesses of the pawls, respectively.

Preferably, the ratchet hand tool further comprises a retaining ring configured to connect the operating member and the positioning member.

Preferably, the operating member further has a through hole communicating with the first accommodating space.

Preferably, the ratchet hand tool further comprises a sleeve disposed on the operating member.

Preferably, the pushing portions are adjacent to the stop groove in a circumferential direction of the positioning member.

Preferably, the positioning member is located between the operating member and the grip, and the stop groove is disposed on one end of the positioning member, opposite to the grip.

Preferably, one side of each pawl is inserted into the stop groove and has the pawl toothed portion to be selectively engaged with the inner toothed portion, and another side of each pawl has the pivot portion pivotally disposed in the corresponding pivot groove.

Preferably, one end of the shaft member is a semi-cylinder, and the pivot grooves are disposed on a rectangular surface of the semi-cylinder.

According to the above technical features, the following effects can be achieved:

1. Through the pivot grooves to accommodate the pawls and the internal toothed portion instead of a general external gear structure, the pawls and the first elastic member can be directly disposed in the first accommodating space of the operating member and correspond to the internal toothed portion. No additional space is required. The overall volume can be reduced, the structure is simple, the installation is easy, and it is easier to implement.

2. Through the pushing portions, the pawls accommodated in the pivot grooves, and the internal toothed portion, it is convenient to use the ratchet hand tool in a narrow working space, and the efficiency of using the ratchet tool can be improved.

3. Through the second elastic member, the steel ball can be easily switched and positioned into a desired positioning groove, and the operation mode of the ratchet hand tool can be selected according to actual needs.

4. Different screwdriver bits and wrench bits can be mounted to the sleeve, so it is more convenient for the ratchet hand tool to be applied to different occasions.

5. Through the through hole of the operating member, it is convenient to separate the operating member and the positioning member for maintenance or replacement.

### BRIEF DESCRIPTION OF THE DRAWINGS

FIG. 1 is a perspective view in accordance with a preferred embodiment of the present invention;

FIG. 2 is an exploded view in accordance with the preferred embodiment of the present invention;

FIG. 3 is a first cross-sectional view in accordance with the preferred embodiment of the present invention;

FIG. 4 is a second cross-sectional view in accordance with the preferred embodiment of the present invention;

FIG. 5 is a third cross-sectional view in accordance with the preferred embodiment of the present invention;

FIG. 6 is a fourth cross-sectional view in accordance with the preferred embodiment of the present invention;

FIG. 7 is a first schematic view showing the operation of the preferred embodiment of the present invention;

FIG. 8 is a second schematic view showing the operation of the preferred embodiment of the present invention;

FIG. 9 is a third schematic view showing the operation of the preferred embodiment of the present invention; and

FIG. 10 is a fourth schematic view showing the operation of the preferred embodiment of the present invention.

### DETAILED DESCRIPTION OF THE PREFERRED EMBODIMENTS

Embodiments of the present invention will now be described, by way of example only, with reference to the accompanying drawings.

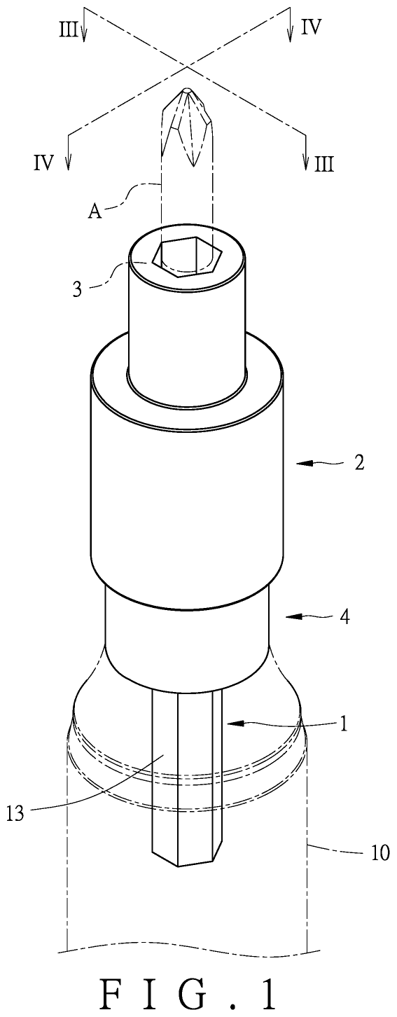

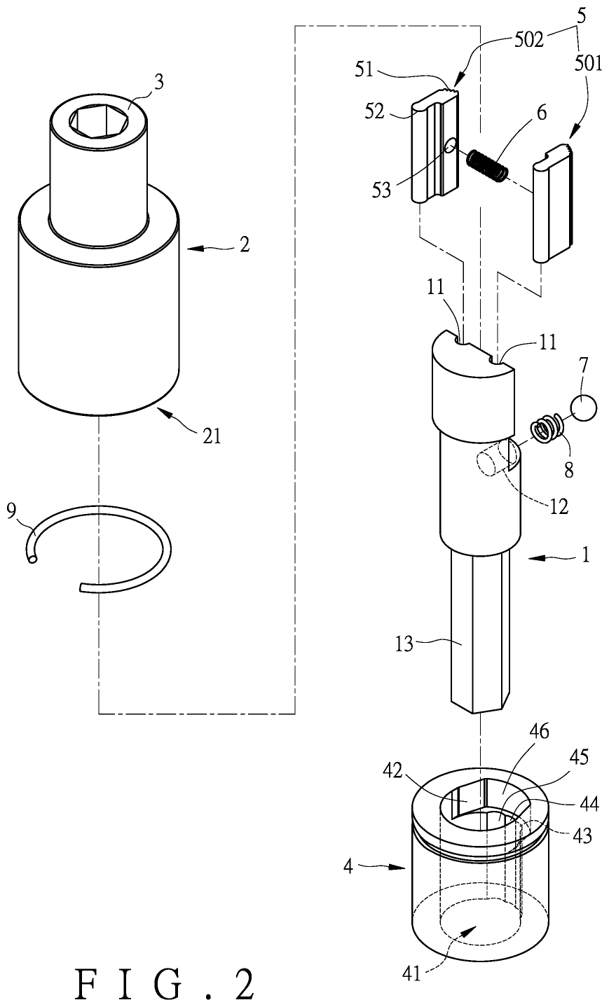

As shown in FIG. 1 and FIG. 2, the present invention discloses a ratchet hand tool, comprising a grip 10, a shaft member 1, an operating member 2, a sleeve 3, a positioning member 4, two pawls 5, a first elastic member 6, a steel ball 7, and a second elastic member 8. In an embodiment of the present invention, both the first elastic member 6 and the second elastic member 8 are springs.

The shaft member 1 is disposed in the grip 10. The shaft member 1 has two pivot grooves 11, a groove 12, and a shaft rod 13. More specifically, one end of the shaft member 1 is a semi-cylinder. The pivot grooves 11 are disposed on a rectangular surface of the semi-cylinder 13. The other end of the shaft member 1 is the shaft rod 13. The shaft rod 13 is inserted into the grip 10. The sleeve 3 is connected to the operating member 2. The sleeve 3 may be integrally formed with the operating member 2 when being manufactured. According to actual needs, one of bits A having different shapes or functions is selected to be fitted onto the sleeve 3. The screwdriver bits A may be replaced with wrench bits or other hand tools. It is more convenient for applying the ratchet hand tool to different occasions.

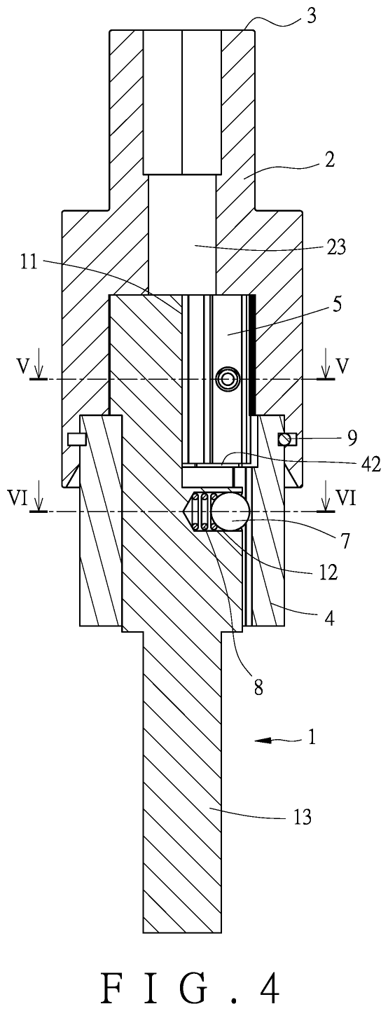

Referring to FIGS. 2 to 4, in cooperation with FIG. 1, the steel ball 7 and the second elastic member 8 are disposed in the groove 12 of the grip 10. More specifically, one end of the second elastic member 8 abuts against the steel ball 7, and the other end of the second elastic member 8 abuts against the bottom wall of the groove 12, so that the steel ball 7 can enter or leave the groove 12.

The operating member 2 is sleeved on the shaft member 1. The operating member 2 is hollow to form a first accommodating space 21. The operating member 2 has an internal toothed portion 22 corresponding to the first accommodating space 21. The operating member 2 further has a through hole 23 communicating with the first accommodating space 21 and the sleeve 3.

The positioning member 4 is sleeved on the shaft member 1 and is located between the operating member 2 and the grip 10. A retaining ring 9 is provided to connect the operating member 2 and the positioning member 4. The retaining ring 9 has a circular cross-section. The positioning member 4 is hollow to form a second accommodating space 41 communicating with the first accommodating space 21. The positioning member 4 has two pushing portions 42 corresponding to the second accommodating space 41. The positioning member 4 has a first positioning groove 43, a second positioning groove 44 and a third positioning groove 45 that are adjacent and arranged in sequence in the counterclockwise direction. The steel ball 7 is selectively positioned in the first positioning groove 43, the second positioning groove 44 or the third positioning groove 45. One end of the positioning member 4, opposite to the grip 10, is recessed to form a stop groove 46 corresponding to the second accommodating space 41. More specifically, the stop groove 46 is adjacent to the pushing portions 42 in the circumferential direction of the positioning member 4. The stop groove 46 is adjacent to the first positioning groove 43, the second positioning groove 44 and the third positioning groove 45 in the axial direction of the positioning member 4.

The pawls 5 are defined as a first pawl 501 and a second pawl 502. The first pawl 501 and the second pawl 502 each include a pawl toothed portion 51 and a pivot portion 52 that are integrally formed. One side of each of the first pawl 501 and the second pawl 502 is inserted into the stop groove 46. The pawl toothed portion 51 is selectively engaged with the inner toothed portion 22 of the operating member 2. The pivot portion 52 at the other side of each of the first pawl 501 and the second pawl 502 is accommodated in the corresponding pivot groove 11 of the shaft member 1, so that the first pawl 501 and the second pawl 502 correspond to the first accommodating space 21 and the second accommodating space 41. The pawls 5 are pivotal relative to the shaft member 1 through the pivot portion 52 and the pivot groove 11. The pawls 5 correspond to the pushing portions 42, respectively. Each of the pawls 5 has a recess 53. When the pawls 5 are disposed in the pivot grooves 11, the first pawl 501 is on the same side as the first positioning groove 43, and the second pawl 502 is on the same side as the third positioning groove 45.

The first elastic member 6 is disposed between the first pawl 501 and the second pawl 502. Two ends of the first elastic member 6 are disposed in the recesses 53 of the first pawl 501 and the second pawl 502, respectively.

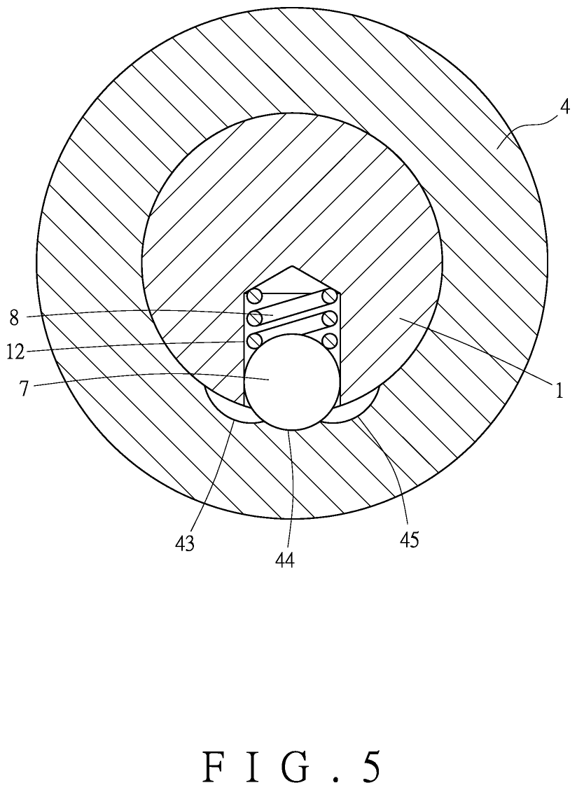

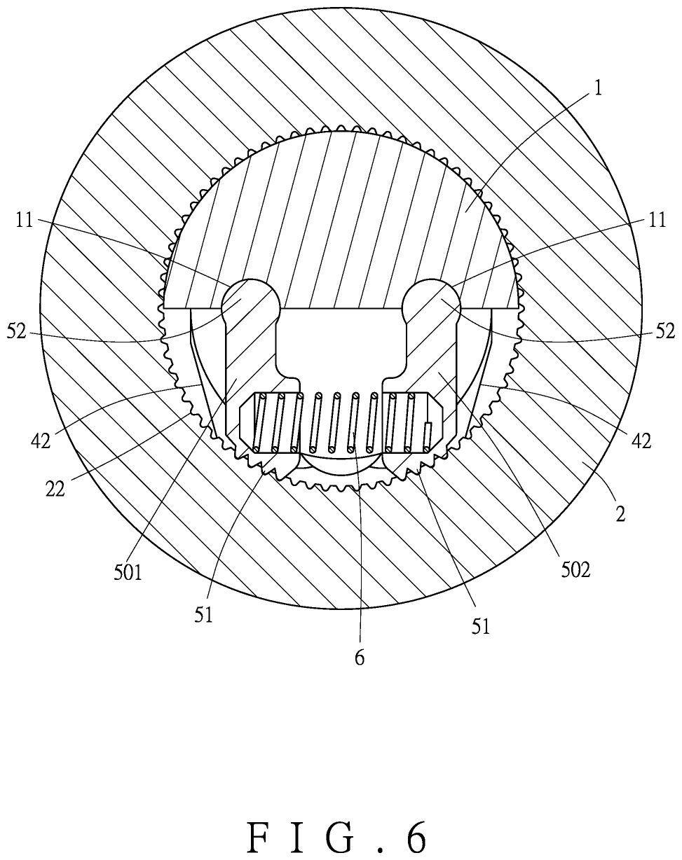

Referring to FIG. 5 and FIG. 6, in cooperation with FIG. 1, before using the ratchet hand tool, the steel ball 7 is first adjusted and positioned to the first positioning groove 43, the second positioning groove 44 or the third positioning groove 45, and a screwdriver bit A is selected corresponding to an article to be operated. For example, the screwdriver bit A corresponds to a screw, and then the ratchet hand tool can be used for locking or unlocking the screw. Through the second elastic member 8, the steel ball 7 can enter and leave the groove 12 along the wall of the first positioning groove 43, the second positioning groove 44 or the third positioning groove 45. It is convenient to switch and position the steel ball 7 into a desired positioning groove, so as to select the operation mode of the ratchet hand tool according to actual needs.

For the ratchet hand tool to be operated as a general hand tool, the steel ball 7 is first adjusted and positioned to the second positioning groove 44 by applying a force. When the steel ball 7 is adjusted and positioned to the second positioning groove 44, the pushing portions 42 are not in contact with the first pawl 501 and the second pawl 502 while the pawl toothed portions 51 of the first pawl 501 and the second pawl 502 are engaged with the inner toothed portion 22 of the operating member 2. The first elastic member 6 is locate between the first pawl 501 and the second pawl 502, so that the shaft member 1, the operating member 2, the positioning member 4, the first pawl 501 and the second pawl 502 do not move relatively, so as to operate the ratchet hand tool as a general hand tool.

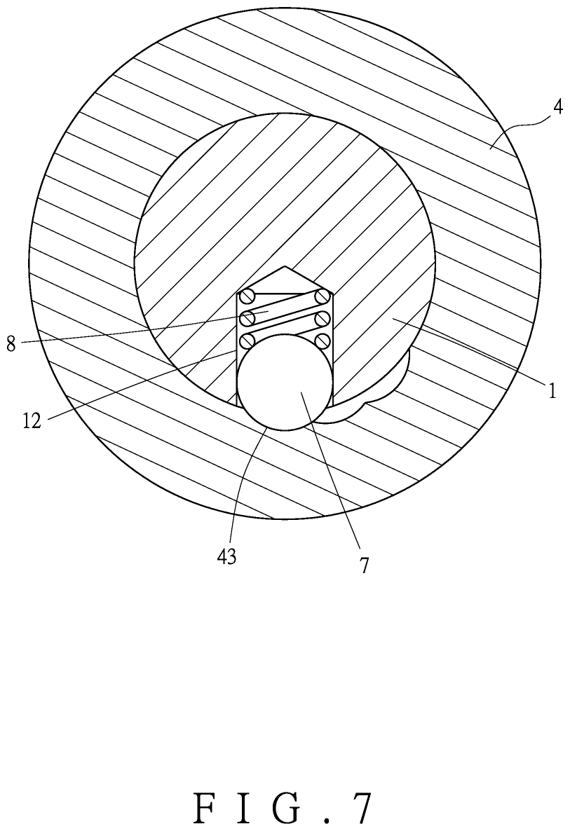

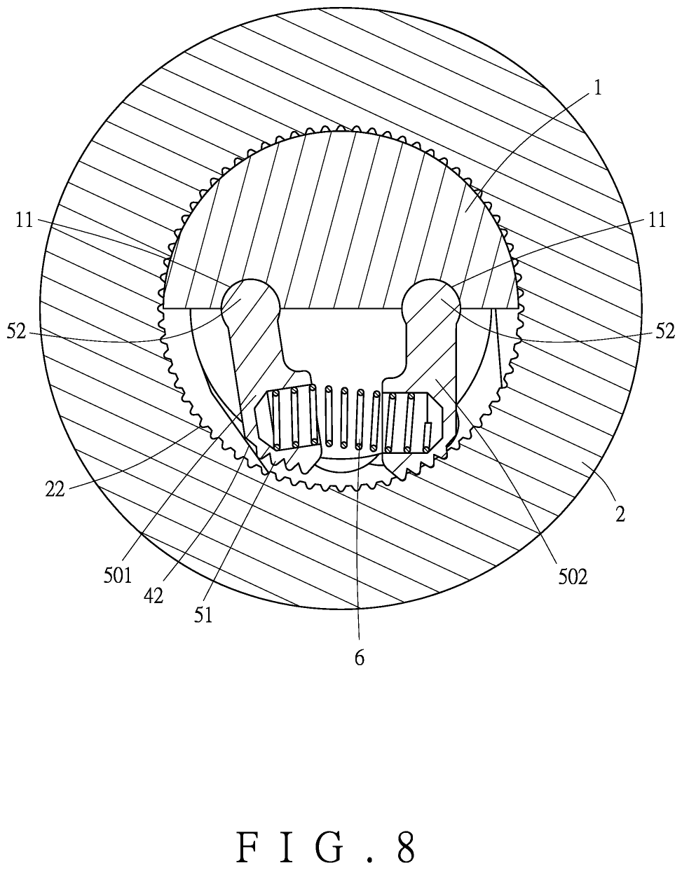

Referring to FIG. 7 and FIG. 8, in cooperation with FIG. 1, the screw having right-hand threads is described as an example. When the ratchet hand tool is rotated clockwise to lock the screw, the steel ball 7 is first adjusted and positioned to the first positioning groove 43. At this time, if the shaft member 1 is rotated counterclockwise, the pushing portion 42 will push against the first pawl 501 to disengage the pawl toothed portion 51 of the first pawl 501 from the inner toothed portion 22. The first pawl 501 is pivoted through the pivot groove 11, and the first elastic member 6 is pressed by the first pawl 501 to store an elastic potential energy. Since the first elastic member 6 is pressed against the second pawl 502, the second pawl 502 cannot be rotated counterclockwise because the pawl toothed portion 51 is engaged with the internal toothed portion 22, such that the shaft member 1 cannot be rotated counterclockwise relative to the operating member 2. If the shaft member 1 is turned clockwise, the pushing portion 42 will stop pushing against the first pawl 501. The first elastic member 6 releases the elastic potential energy and pushes against the first pawl 501, so that the first pawl 501 is pivoted through the pivot groove 11. The pawl toothed portion 51 of the first pawl 501 is engaged with the internal toothed portion 22 again, and the pawl toothed portion 52 of the second pawl 502 advances clockwise on the internal toothed portion 22 to engage with the next tooth, so that the shaft member 1 can be rotated clockwise relative to the operating member 2. In this way, as long as the shaft member 1 is turned back and forth, the screwdriver bit A will continue to rotate clockwise to lock the screw, which can improve the efficiency of using the ratchet tool.

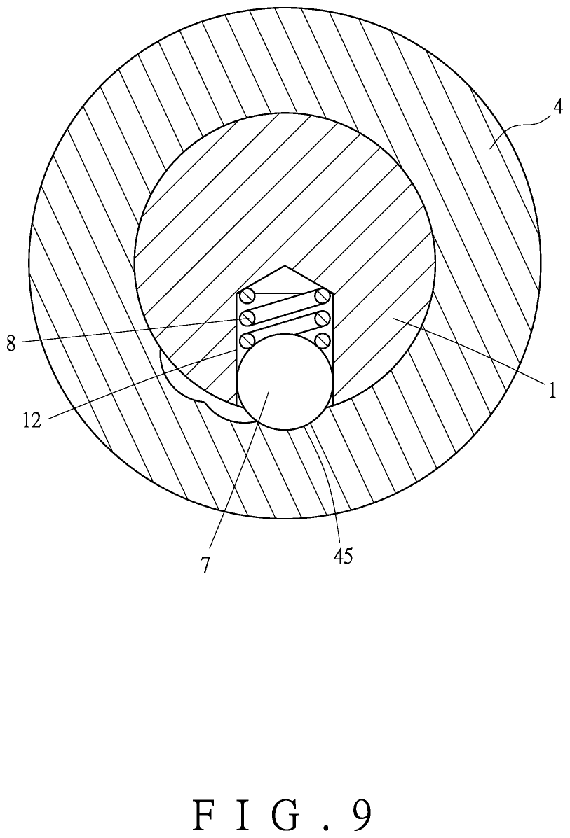

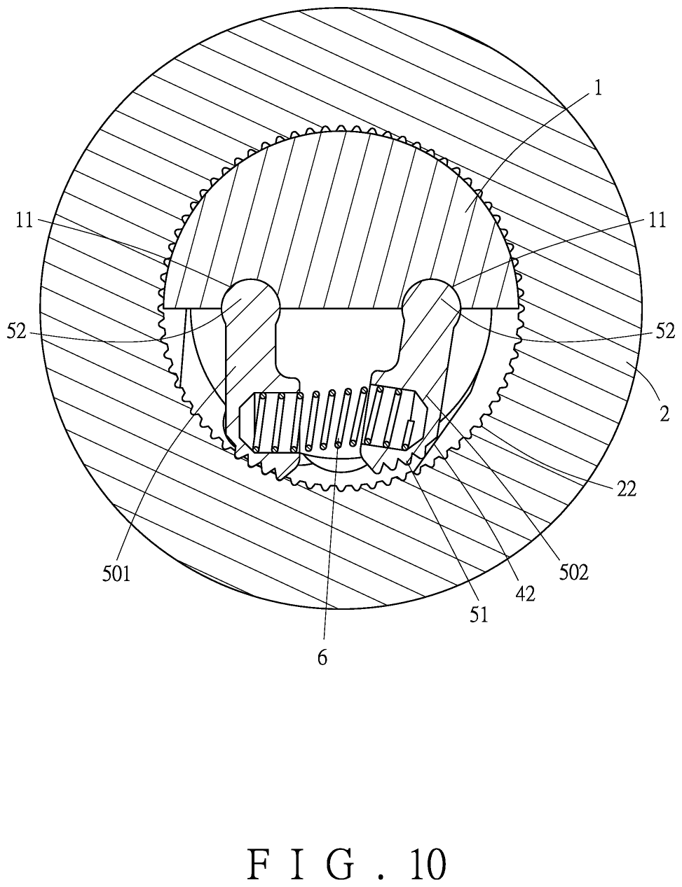

Referring to FIG. 9 and FIG. 10, in cooperation with FIG. 1, when it is necessary to rotate the ratchet hand tool counterclockwise to unlock the screw, the steel ball 7 is first adjusted and positioned to the third positioning groove 45. At this time, if the shaft member 1 is rotated clockwise, the pushing portion 42 will push against the second pawl 502 to disengage the pawl toothed portion 51 of the second pawl 502 from the inner toothed portion 22. The second pawl 502 is pivoted through the pivot groove 11, and the first elastic member 6 is pressed by the second pawl 502 to store an elastic potential energy. Since the first elastic member 6 is pressed against the first pawl 501, the first pawl 501 cannot be rotated clockwise because the pawl toothed portion 51 is engaged with the internal toothed portion 22, such that the shaft member 1 cannot be rotated clockwise relative to the operating member 2. If the shaft member 1 is turned counterclockwise, the pushing portion 42 will stop pushing against the second pawl 502. The first elastic member 6 releases the elastic potential energy and pushes against the second pawl 502, so that the second pawl 502 is pivoted through the pivot groove 11. The pawl toothed portion 51 of the second pawl 502 is engaged with the internal toothed portion 22 again, and the pawl toothed portion 51 of the first pawl 501 advances counterclockwise on the internal toothed portion 22 to engage with the next tooth, so that the shaft member 1 can be rotated counterclockwise relative to the operating member 2. In this way, as long as the shaft member 1 is turned back and forth, the screwdriver bit A will continue to rotate counterclockwise to unlock the screw, which can improve the efficiency of using the ratchet tool.

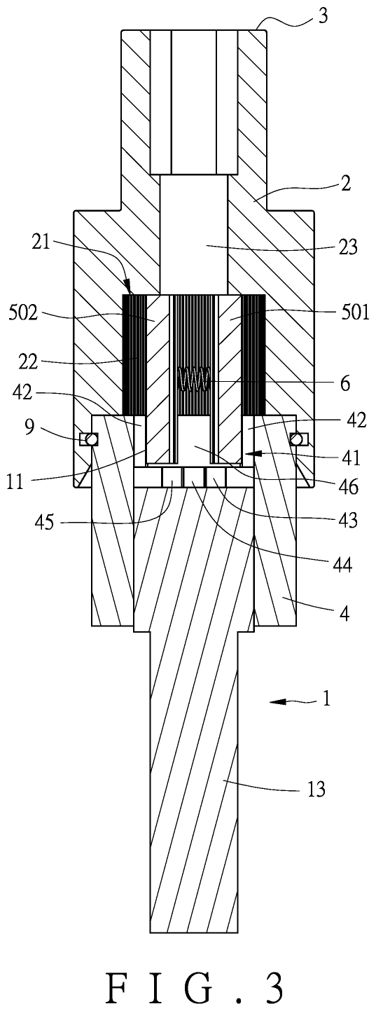

Please refer to FIG. 2 and FIG. 3 again. Instead of a general external gear structure, through the internal toothed portion 22 of the operating member 2 and the pawls 5, the pawls 5 and the first elastic member 6 can be directly disposed in the first accommodating space 21 of the operating member 2 and correspond to the internal toothed portion 22. There is no need for an additional space to accommodate the pawls 5 and the first elastic member 6. The overall volume of the ratchet hand tool can be reduced, the structure is simple, the installation is easy, and it is easier to implement. It is convenient to use the ratchet hand tool in a narrow working space, and the efficiency of using the ratchet tool can be improved.

When the operating member 2 and the positioning member 4 are to be separated for maintenance or replacement, a tool, such as a screw or a long and thin tool, can be directly inserted from the sleeve 3 into the first accommodating space 21 of the operating member 2 along the through hole 23 of the operating member 2 to push against the pawls 5. The pawls 5 pushes out the positioning member 4 through the stop groove 46, so that the operating member 2 and the positioning member 4 are separated for maintenance or replacement. In addition, the cross-sectional shape of the retaining ring 9 is circular, which facilitates the separation of the operating member 2 and the positioning member 4.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. a ratchet hand tool, comprising:
a grip;
a shaft member, disposed in the grip, the shaft member having two pivot grooves;
an operating member being sleeved on the shaft member, the operating member being hollow to form a first accommodating space, the operating member having an internal toothed portion corresponding to the first accommodating space;
a positioning member, sleeved on the shaft member and adjacent to the operating member, the positioning member being hollow to form a second accommodating space communicating with the first accommodating space, the positioning member being recessed to form a stop groove and having two pushing portions adjacent to the stop groove, the stop groove and the pushing portions corresponding to the second accommodating space;
two pawls, each having a pawl toothed portion that is selectively engaged with the inner toothed portion and a pivot portion that is integrally formed with the pawl toothed portion and pivotally disposed in a corresponding one of the pivot grooves, the pawls corresponding to the first accommodating space and the second accommodating space, the pawls corresponding to the pushing portions, respectively; and
a first elastic member, disposed between the pawls;
wherein when one of the pushing portions pushes against a corresponding one of the pawls to disengage the pawl toothed portion of the corresponding pawl from the inner toothed portion, the corresponding pawl is pivoted through the corresponding pivot groove, and the first elastic member is pressed to store an elastic potential energy;
wherein when the pushing portion stops pushing against the corresponding pawl, the first elastic member releases the elastic potential energy so that the corresponding pawl is pivoted through the corresponding pivot groove, and the pawl toothed portion of the corresponding pawl is engaged with the internal toothed portion.

2. The ratchet hand tool as claimed in claim 1, wherein the shaft member has a shaft rod disposed in the grip.

3. The ratchet hand tool as claimed in claim 1, wherein each of the pawls has a recess, and two ends of the first elastic member are disposed in the recesses of the pawls, respectively.

4. The ratchet hand tool as claimed in claim 1, further comprising a retaining ring configured to connect the operating member and the positioning member.

5. The ratchet hand tool as claimed in claim 1, wherein the operating member further has a through hole communicating with the first accommodating space.

6. The ratchet hand tool as claimed in claim 1, further comprising a sleeve disposed on the operating member.

7. The ratchet hand tool as claimed in claim 1, wherein the pushing portions are adjacent to the stop groove in a circumferential direction of the positioning member.

8. The ratchet hand tool as claimed in claim 1, wherein the positioning member is located between the operating member and the grip, and the stop groove is disposed on one end of the positioning member, opposite to the grip.

9. The ratchet hand tool as claimed in claim 1, wherein one side of each pawl is inserted into the stop groove and has the pawl toothed portion to be selectively engaged with the inner toothed portion, and another side of each pawl has the pivot portion pivotally disposed in the corresponding pivot groove.

10. The ratchet hand tool as claimed in claim 1, wherein one end of the shaft member is a semi-cylinder, and the pivot grooves are disposed on a rectangular surface of the semi-cylinder.
